(19) United States
(12) Patent Application Publication
(10) Pub. No.: US 2026/0342457 A1
(43) Pub. Date: Oct. 29, 2026

(54) APPARATUS AND METHOD OF GENERATING AN EVM FOR MIMO TRANSMISSION

(71) Applicant: Lenovo (Singapore) Pte. Limited, Singapore (SG)

(72) Inventor: Colin Frank, Park Ridge, IL (US)

(73) Assignee: Lenovo (Singapore) Pte. Limited, Singapore (SG)

(21) Appl. No.: 19/111,715

(22) PCT Filed: Sep. 19, 2023
(86) PCT No.: PCT/IB2023/059259

§ 371 Date: Mar. 13, 2025

Related U.S. Application Data
(60) Provisional application No. 63/411,512, filed on Sep. 29, 2022.

(51) Int. Cl. H04B 17/309; H04B 7/0426

(52) U.S. Cl. CPC H04B 17/309; H04B 7/0426

(57) ABSTRACT

A multiple-layer transmission can be conductively received (410) with each layer having a modulation type. Layers can be separated (420) from the multiple-layer transmission by using a matrix MIMO receiver having matrix coefficients. An EVM can be measured (430) for at least one layer for the separated layers. An increase in an allowed MPR can be determined (440) for the modulation type for the at least one layer. The measured EVM for the at least one layer can be increased (450) by a function of an allowed MPR increase for the modulation type.

### BACKGROUND

### 1. Field

The present disclosure is directed to an apparatus and method of communication on a wireless network. More particularly, the present disclosure is directed to generating an Error Vector Magnitude (EVM) for a Multiple-Input Multiple-Output (MIMO) transmission.

### 2. Introduction

Presently, wireless communication devices, such as User Equipments (UEs), communicate with other communication devices using wireless signals. EVM is a measure of modulation accuracy, or how well the power amplifier in a UE is transmitting information, represented by the varying phase and amplitude of a Radio-Frequency (RF) signal. As such, the UE may send a transmission signal, such as a multi-layer transmission, to a test equipment. Upon receiving the transmission signal, the test equipment calculates a transmitter EVM for multi-layer transmission. In other examples, the UE may transmit to a base station and the base station calculates a transmitter EVM for multi-layer transmission.

### BRIEF DESCRIPTION OF THE DRAWINGS

In order to describe the manner in which advantages and features of the disclosure can be obtained, a description of the disclosure is rendered by reference to specific embodiments thereof which are illustrated in the appended drawings. These drawings depict only example embodiments of the disclosure and are not therefore to be considered to be limiting of its scope. The drawings may have been simplified for clarity and are not necessarily drawn to scale.

FIG. 1 is an example block diagram of a system according to a possible embodiment;

FIG. 2 is an example block diagram illustrating a communication arrangement for determining an EVM of a transmitter according to a possible embodiment;

FIG. 3 is an example flowchart of a method of operation of a device according to a possible embodiment;

FIG. 4 is an example flowchart of a method of operation of a device according to a possible embodiment;

FIG. 5 is an example block diagram of an apparatus according to a possible embodiment;

FIG. 6 is an example illustration of a relationship between EVM and MPR according to a possible embodiment;

FIG. 7 is an example flowchart of a method in a device according to a possible embodiment; and

FIG. 8 is an example flowchart of a method in a device according to a possible embodiment.

### DETAILED DESCRIPTION

Embodiments provide a method and apparatus for communicating on a wireless network. Embodiments can also provide for generating an EVM for a MIMO transmission. Embodiments can also provide a method for defining EVM for multi-antenna multi-layer transmission using a conductive measurement, such as a measurement of a conductively received transmission.

According to a possible embodiment, a multiple-layer transmission can be conductively received with each layer having a modulation type. Layers can be separated from the multiple-layer transmission by using a matrix MIMO receiver having matrix coefficients. An EVM can be measured for at least one layer for the separated layers. An increase in an allowed Maximum Power Reduction (MPR) can be determined for the modulation type for the at least one layer. The measured EVM for the at least one layer can be increased by a function of an allowed MPR increase for the modulation type.

According to a possible embodiment, a multiple-layer transmission can be conductively received with each layer having a modulation type. Layers can be separated from the multiple-layer transmission by using a matrix MIMO receiver having matrix coefficients. An EVM can be measured for at least one layer of the separated layers. A maximum combining gain of the MIMO receiver can be determined for each layer based on the receiver matrix coefficients. An adjusted EVM can be generated by multiplying the measured EVM by a fraction of a square root of the maximum combining gain.

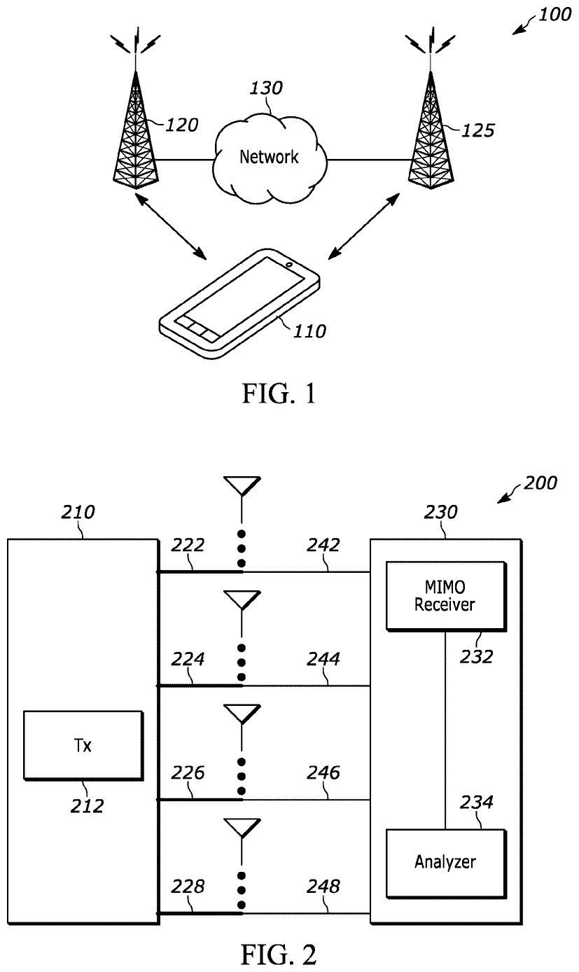

FIG. 1 is an example block diagram of a system 100 according to a possible embodiment. The system 100 can include a UE 110, at least one network entity 120 and 125, and a network 130. The UE 110 can be a wireless wide area network device, a user device, a wireless terminal, a portable wireless communication device, a smartphone, a cellular telephone, a flip phone, a personal digital assistant, a smartwatch, a personal computer, a tablet computer, a laptop computer, a selective call receiver, an IoT device, or any other user device that is capable of sending and receiving communication signals on a wireless network. The at least one network entity 120 and 125 can be a wireless wide area network base station, can be a NodeB, can be an eNB, can be a gNB, such as a 5G NodeB, can be an unlicensed network base station, can be an access point, can be a base station controller, can be a network controller, can be a transmit-receive point, can be a different type of network entity from the other network entity, and/or can be any other network entity that can provide wireless access between a UE and a network.

The network 130 can include any type of network that is capable of sending and receiving wireless communication signals. For example, the network 130 can include a wireless communication network, a cellular telephone network, a TDMA-based network, a CDMA-based network, an OFDMA-based network, an LTE network, a NR network, a 3GPP-based network, a 5G network, a satellite communications network, a high-altitude platform network, the Internet, and/or other communications networks.

In operation, the UE 110 can communicate with the network 130 via at least one network entity 120. For example, the UE 110 can send and receive control signals on a control channel and user data signals on a data channel.

According to 3GPP Technical Specification (TS) 38.101, the Error Vector Magnitude is a measure of the difference between the reference waveform and the measured waveform. This difference is called the error vector. Before calculating the EVM the measured waveform is corrected by the sample timing offset and RF frequency offset. Then the carrier leakage shall be removed from the measured waveform before calculating the EVM.

The measured waveform is further equalized using the channel estimates subjected to an EVM equalizer spectrum flatness requirement. For DFT-s-OFDM waveforms, the EVM result is defined after the front-end FFT and IDFT as the square root of the ratio of the mean error vector power to the mean reference power expressed as a percentage. For CP-OFDM waveforms, the EVM result is defined after the front-end FFT as the square root of the ratio of the mean error vector power to the mean reference power expressed as a percentage.

The basic EVM measurement interval in the time domain is one preamble sequence for the PRACH and one slot for PUCCH and PUSCH in the time domain. The EVM measurement interval is reduced by any symbols that contain an allowable power transient in the measurement interval.

The RMS average of the basic EVM measurements over 10 subframes for the average EVM case, and over 60 subframes for the reference signal EVM case, for the different modulation schemes shall not exceed the values specified in Table 6.4.2.1-1 for the parameters defined in Table 6.4.2.1-2. For EVM evaluation purposes, all 13 PRACH preamble formats and all 5 PUCCH formats are considered to have the same EVM requirement as QPSK modulated.

TABLE 6.4.2.1-1
Requirements for Error Vector Magnitude

| Parameter | Unit | Average EVM Level |
|---|---|---|
| Pi/2-BPSK | % | 30 |
| QPSK | % | 17.5 |
| 16 QAM | % | 12.5 |
| 64 QAM | % | 8 |
| 256 QAM | % | 3.5 |

TABLE 6.4.2.1-2
Parameters for Error Vector Magnitude

| Parameter | Unit | Level |
|---|---|---|
| UE Output Power | dBm | ≥ Table 6.3.1-1 |
| UE Output Power for 256 | dBm | ≥ Table 6.3.1-1 + 10 dB |
| QAM | | |
| Operating conditions | | Normal conditions |

FIG. 2 is an example block diagram illustrating a communication arrangement 200 for determining an EVM of a transmitter according to a possible embodiment. The arrangement 200 can include a UE 210, such as the UE 110, and an evaluator 230. The UE 210 can include a transmitter 212 and a plurality of antenna connectors 222, 224, 226, and 228. The evaluator 23 can include a MIMO receiver 232, an analyzer 234, and a plurality of connectors 242, 244, 246, and 248. A plurality of transmitter antennas, such as Tx antennas, may or may not be connected to antenna connectors and arranged into one or more antenna ports when the UE 210 is connected to the evaluator 230. Each antenna port can include multiple antennas with an antenna connector for each antenna. The transmitter 212 can generate a multiple-layer transmission signal for MIMO and transmit the multiple-layer transmission signal to the evaluator 230.

The evaluator 230 can calculate an EVM of the transmitter 212. In certain embodiments the evaluator 230 can be test equipment, can be located at the network entity 120, and/or can be a part of the UE 110. In other embodiments, the 212 may be an embodiment of the network entity 120, where the evaluator 220 can be an embodiment of test equipment another network entity. The evaluator 230 can measure the multiple-layer transmission signal using a MIMO receiver 232 and can calculate an EVM of the transmitter 212 using the analyzer 234 according to the below descriptions.

According to a possible embodiment based on a maximum combining gain, a connector 242, 244, 246, or 248 can conductively receive a multiple-layer transmission with each layer having a modulation type. Conductively receiving can include receiving the transmission directly from at least one antenna connector 222, 224, 226, or 228. Modulation types can include DFT-s-OFDM, DFT-s-OFDM Pi/2 BPSK, DFT-s-OFDM QPSK, DFT-s-OFDM 16 QAM, DFT-s-OFDM 64 QAM, DFT-s-OFDM 256 QAM, CP-OFDM, CP-OFDM QPSK, CP-OFDM 16 QAM, CP-OFDM 64 QAM, CP-OFDM 256 QAM, and other modulation types.

The receiver 232 can separate the multiple-layer transmission by using a matrix MIMO receiver having matrix coefficients. The analyzer 234 can measure an EVM for at least one layer of the separated multiple-layer transmission. The analyzer 234 can determine a maximum combining gain of the MIMO receiver for each layer based on the receiver matrix coefficients. The analyzer 234 can generate an adjusted EVM by multiplying the measured EVM by a fraction of a square root of the maximum combining gain.

The analyzer 234 can compare the adjusted EVM to an EVM threshold predefined for the modulation type of at least one layer. The MIMO receiver 232 can be a zero-forcing MIMO receiver. The MIMO receiver 232 can be a linear unbiased MMSE MIMO receiver. The MIMO receiver 232 can be a pseudo-inverse MIMO receiver. Separating the layers can include separating the layers prior to EVM measurement.

The maximum combining gain can be determined for a particular layer based on a fraction of a pre-set maximum combining gain, a MIMO receiver matrix of the MIMO receiver, and a matrix of a transmission channel. For example, the maximum combining gain is computed as

$$f \cdot {( \frac{{( {\sum }_{j = 1}^{4} \vert {B}_{i , j} \vert {σ}_{i} )}^{2}}{{\sum }_{j = 1}^{4} {\vert {B}_{i , j} \vert}^{2} {σ}_{i}^{2}} )}^{\frac{1}{2}} ,$$

where f is the fraction of a pre-set maximum combining gain and is a real-valued scalar in an interval (0,1], i represents the particular layer, B=AH, A is the MIMO receiver matrix, and H is the matrix of the transmission channel.

According to a possible embodiment based on an allowed MPR, the connector 242, 244, 246, or 248 can conductively receive a multiple-layer transmission with each layer having a modulation type. Conductively receiving can include receiving the transmission directly from at least one antenna connector 222, 224, 226, or 228. The receiver 232 can separate layers from the multiple-layer transmission by using a matrix MIMO receiver having matrix coefficients.

The analyzer 234 can measure an EVM for at least one layer for the separated layers. The analyzer 234 can determine an increase in an allowed MPR for the modulation type for the at least one layer. The analyzer 234 can increase the measured EVM for the at least one layer by a function of an allowed MPR increase for the modulation type.

The EVM measurement can be increased based on a product of the EVM measurement, a scalar, and an amount of increase of an allowed MPR. For example, the EVM measurement can be increased based on

EVM_{increased}=EVM_{conductive} f·2^{(ΔMPR/2)},

where EVM_{conductive} is the EVM measurement of the conductively received transmission, f is a real-valued scalar in an interval (0,1], ΔMPR is an amount of increase of the allowed MPR in dB, and EVM_{increased} is the increased EVM measurement.

The increase in the allowed MPR can be pre-set according to the modulation type. The increase in the allowed MPR can also be based on a number of antennas used for transmission. The number of antennas can be greater than one. According to a possible embodiment, the allowed MPR can be based on four or more antennas. The analyzer 234 can compare the increased EVM measurement to an allowed EVM to determine whether an allowed EVM requirement is satisfied. The allowed EVM can be different for at least two different modulation types.

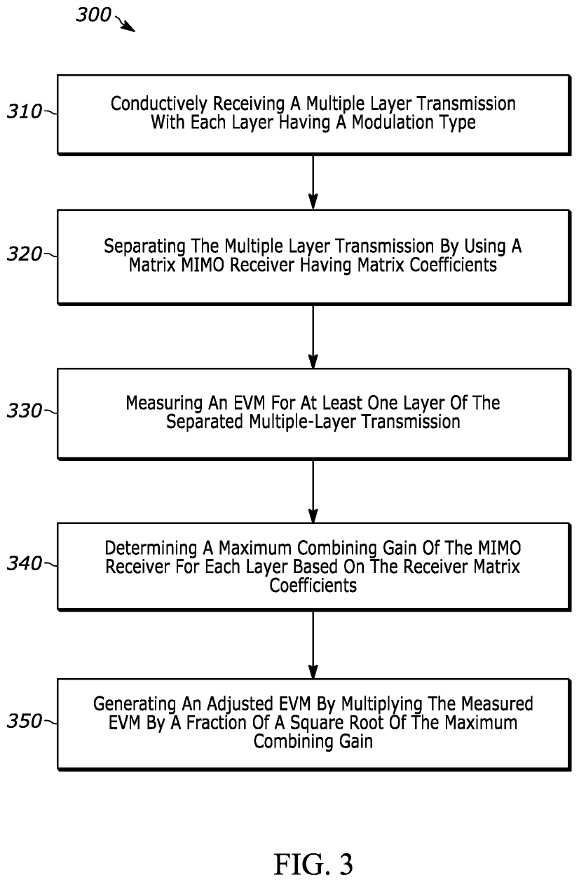

FIG. 3 is an example flowchart 300 of a method of operation of a device, such as the UE 110, the network entity 120, the analyzer 230, or another, device according to a possible embodiment. At 310, the method can include conductively receiving a multiple-layer transmission with each layer having a modulation type. The multiple-layer transmission can be generated at one device and measured using another device. Alternatively, multiple-layer transmission can be generated and measured by a single device.

At 320, the method can include separating layers from the multiple-layer transmission by using a matrix MIMO receiver having matrix coefficients. The MIMO receiver can separate the layers of a multi-layer transmission to allow demodulation of signals, such as by inverting the channel. The MIMO receiver can be different for each frequency. The MIMO receiver can operate on a different Resource Element (RE) at a time, but multiple REs can use the same receiver. MIMO receiver coefficients can be coefficients of a matrix receiver that is predefined. The receiver can be a zero-forcing MIMO receiver, a linear unbiased MMSE MIMO receiver, a pseudo-inverse receiver, a MIMO receiver, or other receiver. Values of the matrix can be used to define the receiver. Separating the layers can include separating the layers prior to EVM measurement.

At 330, the method can include measuring an EVM for at least one layer of the separated layers. EVM can be measured for each layer. Each layer can have the same or different modulation type from at least one other layer. A layer can be a sequence of modulated symbols transmitted from one or more antennas. If multiple layers are transmitted, then each layer is transmitted using a different set of antenna combining coefficients. Two different layers can be two different sequences of modulated symbols. They may or may not be independently modulated. Multiple layers can be transmitted in good signal conditions and they can increase the bandwidth of the channel.

At 340, the method can include determining a maximum combining gain of the MIMO receiver for each layer based on the receiver matrix coefficients. The combining gain can be an improvement in signal-to-noise ratio that results when a signal is received from multiple transmit antennas and the transmitter noise on each of these antennas is independent. When the transmitter noise is correlated, the improvement in signal-to-noise ratio can be reduced. There may be no combining gain with worst-case correlation of the transmitter noise.

The maximum combining gain can be determined for a particular layer based on a fraction of a pre-set maximum combining gain, a MIMO receiver matrix of the MIMO receiver, and a matrix of a transmission channel. For example, the maximum combining gain can be computed as

$$f \cdot {( \frac{{( {\sum }_{j = 1}^{4} \vert {B}_{i , j} \vert {σ}_{i} )}^{2}}{{\sum }_{j = 1}^{4} {\vert {B}_{i , j} \vert}^{2} {σ}_{i}^{2}} )}^{\frac{1}{2}} ,$$

where f is the fraction of a pre-set maximum combining gain and is a real-valued scalar in an interval (0,1], i represents the particular layer, B=AH, A is the MIMO receiver matrix, His a matrix of a transmission channel.

The receiver matrix A can separate layers of a received signal. The matrix H can be a channel upon which a transmission is received. The value for f can be any real-valued scalar chosen in an interval (0, 1], can be a predetermined value, such as set in a standard, and/or can otherwise be determined. For example, a value of one (1) can be used.

At 350, the method can include generating an adjusted EVM by multiplying the measured EVM by a fraction of a square root of the maximum combining gain. The fraction can be one (1). The multiplying of the measured EVM by a fraction of a square root of the maximum combining gain can remove at least some of the maximum combining gain from the conductive EVM measurement. According to a possible embodiment, the method can further include comparing the adjusted EVM to an EVM threshold predefined for the modulation type of at least one layer.

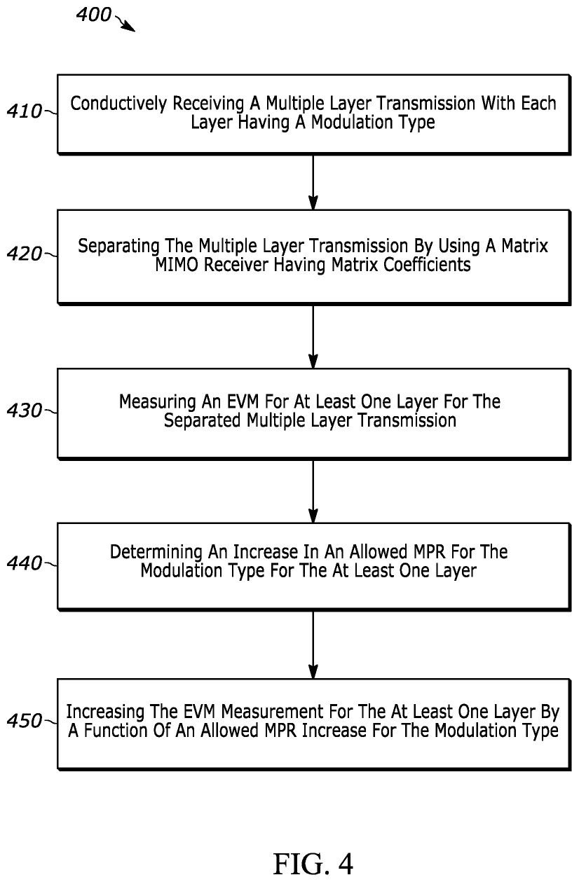

FIG. 4 is an example flowchart 400 of a method of operation of a device, such as the UE 110, the network entity 120, the analyzer 230, or another device, according to a possible embodiment. At 410, the method can include conductively receiving a multiple-layer transmission with each layer having a modulation type. Conductively receiving can include receiving the transmission directly from at least one antenna connector. For example, a device can be physically connected to the antenna connectors to take the measurement. As a further example, measurements can be taken at a plurality of antenna connectors. If directional couplers are used during receiving and measurement, then it may not be necessary to increase the EVM.

At 420, the method can include separating layers from the multiple-layer transmission by using a matrix MIMO receiver having matrix coefficients. At 430, the method can include measuring an EVM for at least one layer for the separated layers.

At 440, the method can include determining an increase in an allowed MPR for the modulation type for the at least one layer. The allowed MPR can be set according to each modulation type and the allowed MPR can be determined to be the set MPR for the particular modulation type. The allowed MPR can be an allowed additional-MPR (A-MPR) or a regular allowed MPR.

At 450, the method can include increasing the measured EVM for the at least one layer by a function of an allowed MPR increase for the modulation type. The increase in the allowed MPR can be pre-set according to the modulation type. The increase in the allowed MPR can be based on a number of antennas used for transmission. For example, the number of antennas can be greater than one, such as at least four antennas. The EVM measurement can be adjusted in accordance with an MPR increase allowed for a type of modulation for a transmission. The EVM measurement can be increased based on a product of the EVM measurement, a scalar, and an amount of increase of an allowed MPR. For example, the EVM measurement can be increased based on

EVM_{increased}=EVM_{conductive} f·2^{(ΔMPR/2)}

where EVM_{conductive} is the EVM measurement of the conductively received transmission, f is a scalar in an interval [0,1], ΔMPR is an amount of increase of an allowed MPR in dB, and EVM_{increased} is the increased EVM measurement.

According to a possible embodiment, the method can include comparing the increased EVM measurement to an allowed EVM to determine whether an allowed EVM requirement is satisfied. The allowed EVM can be different for at least two different modulation types.

It should be understood that, notwithstanding the particular steps as shown in the figures, a variety of additional or different steps can be performed depending upon the embodiment, and one or more of the particular steps can be rearranged, repeated or eliminated entirely depending upon the embodiment. Also, some of the steps performed can be repeated on an ongoing or continuous basis simultaneously while other steps are performed. Furthermore, different steps can be performed by different elements or in a single element of the disclosed embodiments. Additionally, a network entity, such as a base station, transmission and reception point, mobility management entity, or other network entity, can perform reciprocal operations of a UE. For example, the network entity can transmit signals received by the UE and can receive signals transmitted by the UE. The network entity can also process and operate on sent and received signals.

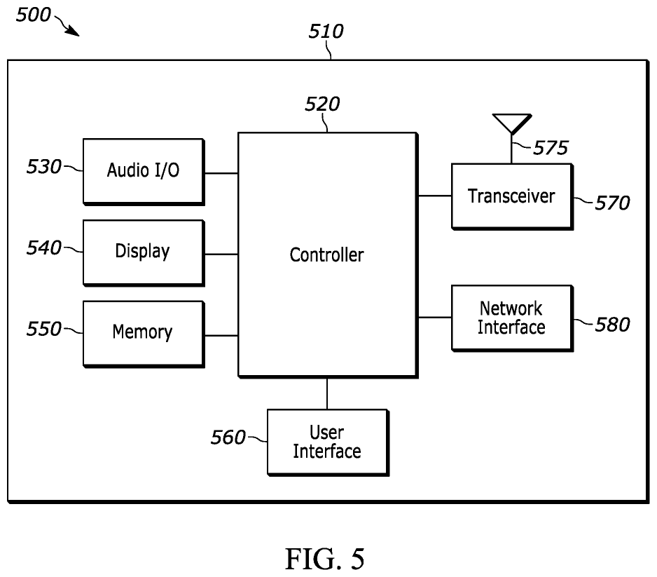

FIG. 5 is an example block diagram of an apparatus 500, such as the UE 110, the network entity 120, or any other wireless communication device disclosed herein, according to a possible embodiment. At least some parts of the apparatus 500 can also be in the evaluator 230. The apparatus 500 can include a housing 510, a controller 520 coupled to the housing 510, audio input and output circuitry 530 coupled to the controller 520, a display 540 coupled to the controller 520, a memory 550 coupled to the controller 520, a user interface 560 coupled to the controller 520, a transceiver 570 coupled to the controller 520, at least one antenna port 575, such as an array of multiple antennas, coupled to the transceiver 570, and a network interface 580 coupled to the controller 520. The apparatus 500 may not necessarily include all of the illustrated elements for different embodiments of the present disclosure. The apparatus 500 can perform the methods described in all the embodiments.

The display 540 can be a viewfinder, an LCD, an LED display, an OLED display, a plasma display, a projection display, a touch screen, or any other device that displays information. The transceiver 570 can be one or more transceivers that can include a transmitter and/or a receiver. The audio input and output circuitry 530 can include a microphone, a speaker, a transducer, or any other audio input and output circuitry. The user interface 560 can include a keypad, a keyboard, buttons, a touch pad, a joystick, a touch screen display, another additional display, or any other device useful for providing an interface between a user and an electronic device. The network interface 580 can be a USB port, an Ethernet port, an infrared transmitter/receiver, an IEEE 1394 port, a wireless transceiver, a WLAN transceiver, or any other interface that can connect an apparatus to a network, device, and/or computer and that can transmit and receive data communication signals. The memory 550 can include a RAM, a ROM, an EPROM, an optical memory, a solid-state memory, a flash memory, a removable memory, a hard drive, a cache, or any other memory that can be coupled to an apparatus.

The apparatus 500 or the controller 520 may implement any operating system, such as Microsoft Windows®, UNIX®, LINUX®, Android™, or any other operating system. Apparatus operation software may be written in any programming language, such as C, C++, Java, or Visual Basic, for example. Apparatus software may also run on an application framework, such as, for example, a Java® framework, a .NET® framework, or any other application framework. The software and/or the operating system may be stored in the memory 550, elsewhere on the apparatus 500, in cloud storage, and/or anywhere else that can store software and/or an operating system. For example, coding for operations can be implemented as firmware programmed into ROM. The apparatus 500 or the controller 520 may also use hardware to implement disclosed operations. For example, the controller 520 may be any programmable processor. Furthermore, the controller 520 may perform some or all of the disclosed operations. For example, at least some operations can be performed using cloud computing and the controller 520 may perform other operations. At least some operations can also be performed computer executable instructions executed by at least one computer processor. Disclosed embodiments may also be implemented on a general-purpose or a special purpose computer, a programmed microprocessor or microprocessor, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, the controller 520 may be any controller or processor device or devices capable of operating an apparatus and implementing the disclosed embodiments. Some or all of the additional elements of the apparatus 500 can also perform some or all of the operations of the disclosed embodiments.

In operation, the apparatus 500 can perform the methods and operations of the disclosed embodiments. The transceiver 570 can transmit and receive signals, including data signals and control signals that can include respective data and control information. The controller 520 can generate and process the transmitted and received signals and information.

According to a possible embodiment for operation of the apparatus 500 as a UE, the controller 520 can generate a multiple-layer transmission with each layer having a modulation type. The transceiver 570 can transmit the generated multiple-layer transmission signal through multiple antennas.

Transmission of the generated multiple-layer transmission can be based on layers separated from a previous multiple-layer transmission by using a matrix MIMO receiver having matrix coefficients. Transmission of the generated multiple-layer transmission can also be based on an EVM measurement for at least one layer of the separated layers.

Transmission of the generated multiple-layer transmission can also be based on a maximum combining gain of the MIMO receiver determined for each layer based on the receiver matrix coefficients. The MIMO receiver can be a zero-forcing MIMO receiver, a linear unbiased MMSE MIMO receiver, a pseudo-inverse MIMO receiver, or other MIMO receiver. The maximum combining gain can be determined for a particular layer based on a fraction of a pre-set maximum combining gain, a MIMO receiver matrix of the MIMO receiver, and a matrix of a transmission channel.

Transmission of the generated multiple-layer transmission can also be based on an adjusted EVM generated by multiplying the measured EVM by a fraction of a square root of the maximum combining gain. Transmission of the generated multiple-layer transmission can also be based on a comparison of the adjusted EVM to an EVM threshold predefined for the modulation type of at least one layer. The adjusted EVM can be compared to an EVM threshold predefined for the modulation type of at least one layer.

According to a possible embodiment for operation of the apparatus 500 as a UE, the controller 520 can generate a multiple-layer transmission with each layer having a modulation type. The transceiver 570 can transmit, the generated multiple-layer transmission signal through multiple antennas. Transmission of the generated multiple-layer transmission can be based on layers separated from a previous multiple-layer transmission of the modulation type by using a matrix MIMO receiver having matrix coefficients. Transmission of the generated multiple-layer transmission can also be based on a measured EVM for at least one layer for the separated layers. Transmission of the generated multiple-layer transmission can also be based on a determined increase in an allowed MPR for the modulation type for the at least one layer

Transmission of the generated multiple-layer transmission can also be based on an increase of the measured EVM for the at least one layer by a function of an allowed MPR increase for the modulation type. The EVM measurement can be increased based on a product of the EVM measurement, a scalar, and an amount of increase of an allowed MPR. The increase in the allowed MPR can be based on a number of antennas used for transmission.

Transmission of the generated multiple-layer transmission can also be based on a comparison of the increased EVM measurement to an allowed EVM to determine whether the allowed EVM requirement is satisfied.

At least some embodiments can provide an EVM definition for conductive MIMO testing. RF requirements enhancement for NR frequency range 1 can include, specifying the UE RF requirements to support 4Tx including 4×4 UL MIMO. At least some embodiments can provide how EVM requirements can be applied for 4×4 UL MIMO.

At least some embodiments can provide error vector magnitude (EVM) for 4×4 UL MIMO. An EVM can be a metric to quantify the combination of all signal impairments in a system.

According to Technical Specification (TS) 38.101-1, the EVM is a measure of the difference between the reference waveform and the measured waveform. This difference is called the error vector. The EVM for closed-loop spatial multiplexing can be further defined as follows: For UE with two transmit antenna connectors in closed-loop spatial multiplexing scheme, specified EVM requirements apply per layer. A layer can be a transmission stream and each layer/stream can be a sequence of modulated symbols. Each layer/stream can be transmitted using a different weighted combination of antenna elements. The number of streams/layers should be less than or equal to the number of transmit antennas.

At least some embodiments can provide details of how the per-layer EVM is defined. For consistency with the 2 Tx case, the EVM requirement for 4×4 UL MIMO can be defined on a per layer basis also. Alternatively, since the precoding matrix for 4×4 UL can be

$$W = \frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ] .$$

It is possible the EVM can be defined per connector since there is a one-to-one mapping between layers and antenna connectors for this case. However, a per-connector EVM definition may not work in the case of one-, two-, or three-layer transmission from four antenna ports since each layer will be transmitted from a combination of antennas if full power is to be achieved. The antenna connector can be where the antenna connects to the transmitter and/or receiver. The antenna connector can also be the point at which test equipment connects for conductive measurements. For Frequency Range 1 (FR1), most tests are conductive and are made using the antenna connectors. Radiated testing can be difficult, time consuming, and expensive.

The term 2 Tx can indicate two transmission antennas. N Tx can indicate N transmit antennas. 4×4 Uplink (UL) MIMO requires four transmit antennas and four receive antennas. Both the number of transmit antennas and the number of receive antennas should be greater than or equal to the number of layers. For example, a 3-layer transmission can use 4 transmit antenna and 5 receive antennas.

If a per-layer EVM definition is used for 4 Tx, then a MIMO receiver can be defined to separate the layers before EVM is measured. For the two transmit antenna case, the linear zero-forcing receiver, the linear unbiased MIMO receiver, or other relevant receiver can be used. In a Technical Report (TR) 38.884 study on enhanced test methods for Frequency Range 2 (FR2) NR UEs, the EVM for rank-2 transmission can be measured using the zero-forcing receiver

G_{ZF}=\tilde{H}⁻¹

where \tilde{H} can be the 2×2 effective channel matrix given by \tilde{H}=HP, H can be the 2×2 channel matrix, and P can be the 2×2 precoding matrix. In this case, a rank-2 transmission can be a transmission with two layers. A rank-N transmission can be a transmission with N layers.

Conductive measurements can be made by having test equipment connect to the antenna connectors. Radiated tests or measurements can be made by measuring signals radiated by the device and not through a connector. There can be a fundamental difference between the EVM measurement for FR1 and FR2 in that for FR2 measurements are radiated while conductive measurements are used for FR1. For radiated tests, the effects of antenna coupling and reverse intermodulation are included in EVM measurement while these aspects are not included in conductive measurements taken at the antenna connectors. As a result, the conductive EVM measurement may underestimate the magnitude of the transmitter noise and may also reflect a combining gain over the transmitter noise that is not achievable if the transmitter noise is highly correlated.

The EVM definition for 2 Tx transmit diversity explicitly removes the combining gain that results if the transmitter noise is uncorrelated by assuming worst case correlation of the transmitter noise. The same approach has been proposed for 4 Tx transmit diversity. A similar approach can be considered when defining EVM for 4×4 UL MIMO as well one-, two-, and three-layer transmission.

For 4×4 UL MIMO, the signal at the antenna connectors is given by

y=H(Wx+n),

where x is the 4×1 data vector, W is the 4×4 precoding matrix, H is the 4×4 channel matrix, and n is the 4×1 vector of transmitter noise at the antenna connectors. If the zero-forcing receiver is used, then the data estimate is given by

\hat{x}=( [symbol] )⁻¹H(Wx+n).

where [symbol] is an estimate of the product of the channel and the precoding matrix. If [symbol] =HW, then

$$\hat{x} = {( H W )}^{- 1} H ( W x + n ) = x + {W}^{- 1} n = x + v ,$$

where v=W⁻¹ n. The covariance of the per-layer transmitter noise is then given by

E(vv^{H})=W⁻¹E(nn^{H})(W⁻¹)^{H}=W^{H}ΣW.

where we have defined Σ=E(nn^{H}) and used the fact that for a unitary matrix W⁻¹=W^{H}. If the transmitter noise at the antenna connectors is uncorrelated so that the covariance matrix can be represented by the diagonal matrix

$$\sum = diag ( {σ}_{1}^{2} , {σ}_{2}^{2} , {σ}_{3}^{2} , {σ}_{4}^{2} ) ,$$

then the resulting noise variance for the i-th layer is given by

$${( {W}^{H} \sum W )}_{i , i} = {\sum }_{j = 1}^{4} {\vert {W}_{j , i} \vert}^{2} {σ}_{i}^{2} .$$

If the transmitter noise is correlated the covariance matrix is not diagonal, then the noise variance for the i-th layer is given by

$${( {W}^{H} \sum W )}_{i , i} = {\sum }_{k = 1}^{4} {\sum }_{j = 1}^{4} {W}_{j , i}^{*} {\sum }_{j , k} {W}_{k , i} .$$

In the Appendix, it is shown that

$${\sum }_{k = 1}^{4} {\sum }_{j = 1}^{4} {W}_{j , i}^{*} {Σ}_{j , k} {W}_{k , i} \leq {( {\sum }_{j = 1}^{4} \vert {W}_{i , j} \vert {σ}_{i} )}^{2}$$

where

$${Σ}_{i , i ,} = {σ}_{i}^{2} .$$

Thus, it coupling between the antennas leads to significant correlation of the transmitter noise, and if the transmitter noise is uncorrelated in the absence of antenna coupling, then the combining gain for the i-th layer can be as large as the ratio

$${G}_{i} = \frac{{( {\sum }_{j = 1}^{4} \vert {W}_{i , j} \vert {σ}_{i} )}^{2}}{{\sum }_{j = 1}^{4} {\vert {W}_{i , j} \vert}^{2} {σ}_{i}^{2}} .$$

This maximum combining gain represents the maximum increase of the layer signal-to-noise ratio that can result if the conducted transmitter noise is independent while the radiated transmitter noise has worst-case correlation due to antenna coupling.

In order to estimate the covariance of the transmitter noise n, it would be necessary to form the estimate

\hat{n}=Ĥ⁻¹y−W\hat{x},

where Ĥ is an estimate of the channel and R is either reference symbols or demodulated data. Alternatively, if the variance of the transmitter noise at each of the antenna connectors is assumed to be equal so that

$${σ}_{i}^{2} = {σ}^{2} ,$$

then the maximum combining gain for the i-th layer is given by

$${G}_{i} = \frac{{( {\sum }_{j = 1}^{4} \vert {W}_{i , j} \vert {σ}_{i} )}^{2}}{{\sum }_{j = 1}^{4} {\vert {W}_{i , j} \vert}^{2}} .$$

In order to avoid underestimating the radiated EVM with a conductive measurement, the maximum combining gain can be removed from the EVM measurement. If EVMᵢ denotes the EVM of the i-th layer, then the signal-to-noise ratio of the i-th layer is given by

$${SNR}_{i} = {( \frac{100}{{EVM}_{i}} )}^{2} .$$

The SNR of the i-th layer with the maximum combining gain removed is then given by

$${SNR}_{i}^{′} = \frac{1}{{G}_{i}} {( \frac{100}{{EVM}_{i}} )}^{2} = {( \frac{100}{{EVM}_{i} \sqrt{{G}_{i}}} )}^{2} = {( \frac{100}{{EVM}_{i}^{′}} )}^{2}$$

where

$${EVM}_{i}^{′} = {EVM}_{i} \sqrt{{G}_{i}} .$$

Thus, the maximum combining gain Gᵢ can be removed from the conductive EVM measurement EVMᵢ by multiplying by the square root of Gᵢ so that

$${EVM}_{i}^{′} = {EVM}_{i} \sqrt{{G}_{i}} .$$

Alternatively, since the correlation of the radiated transmitter noise may not be worst case, it may be better to scale the conductive EVM measurement by a fraction f of the maximum combining gain so that

$${EVM}_{i}^{′} = {EVM}_{i} \cdot f \cdot \sqrt{{G}_{i}} ,$$

where f is in the interval (0, 1].

For the case of the 4×4 UL MIMO precoder given by

$$W = \frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ] ,$$

we have the result that

$$\frac{{( {\sum }_{j = 1}^{4} \vert {W}_{i , j} \vert )}^{2}}{{\sum }_{j = 1}^{4} {\vert {W}_{i , j} \vert}^{2}} = 1 ,$$

so that there is no combining gain for any of the MIMO layers. Thus, for this 4-layer precoder there is no combining gain, and at least from this perspective, the conductive EVM measurement should be similar to the radiated EVM measurement.

It can be noted that if the following 4×4 UL precoder were to be used, such as Transmit Precoding Matrix Index TPMI 3,

$$w = \frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ] , then$$

$$\frac{{( {\sum }_{j = 1}^{4} \vert {W}_{i , j} \vert )}^{2}}{{\sum }_{j = 1}^{4} {\vert {W}_{i , j} \vert}^{2}} = 4 ,$$

with the result that

$${EVM}_{i}^{′} = 2 {EVM}_{i} .$$

At least some embodiments can provide EVM for M-layer transmission from N-antenna ports. In the case that the number of transmission layers is less than the number of antenna ports, the received signal is given by

y=H(Wx+n),

where x is the M×1 data vector, W is the N×M precoding matrix, H is the N×N channel matrix, and n is the N×1 vector of transmitter noise at the antenna connectors. At least two unbiased linear receivers can be used to separate the layers, and these are the unbiased linear Minimum Mean-Squared Error (MMSE) receiver and the pseudo-inverse receiver. The pseudo-inverse receiver A_{pseudo} is given by

A_{pseudo}=((HW)^{H}HW)⁻¹(HW)^{H}

When the pseudo-inverse receiver is applied to the M-layer transmission, the result is

$$\begin{matrix}{A}_{pseudo} y = {( {( HW )}^{H} HW )}^{- 1} {( HW )}^{H} H ( W x + n ) \\ = x + {( {( HW )}^{H} HW )}^{- 1} {( HW )}^{H} H n , \\ = x + v .\end{matrix}$$

where the covariance of the per layer transmitter noise v is given by

E(vv^{H})=BΣB^{H},

and the M×N matrix B is defined as

B=((HW)^{H}HW)⁻¹(HW)^{H}H=A_{pseudo} H.

If the transmitter noise is uncorrelated so that

$$Σ = diag ( {σ}_{1}^{2} , … , {σ}_{N}^{2} ) ,$$

then the noise variance of the i-th layer is given by

$${( {B}^{H} Σ B )}_{i , i} = {\sum }_{j = 1}^{4} {\vert {B}_{j , i} \vert}^{2} {σ}_{i}^{2}$$

If the transmitter noise is correlated so that the covariance matrix is not diagonal, then the noise variance for the i-th layer is given by

$${( {B}^{H} Σ B )}_{i , i} = {\sum }_{k = 1}^{4} {\sum }_{j = 1}^{4} {B}_{j , i}^{*} {Σ}_{j , k} {B}_{k , i} .$$

From the result in the Appendix, it follows that

$${\sum }_{k = 1}^{4} {\sum }_{j = 1}^{4} {B}_{j , i}^{*} {Σ}_{j , k} {B}_{k , i} \leq {( {\sum }_{j = 1}^{4} \vert {B}_{j , i} \vert {σ}_{i} )}^{2} .$$

where

$${Σ}_{i , i ,} = {σ}_{i}^{2} .$$

Thus, if coupling between the antennas leads to significant correlation of the transmitter noise, and if the transmitter noise is uncorrelated in the absence of antenna coupling, then the maximum combining gain for the i-th layer is given by

$${G}_{i} = \frac{{( {\sum }_{j = 1}^{4} \vert {B}_{i , j} \vert {σ}_{i} )}^{2}}{{\sum }_{j = 1}^{4} {\vert {B}_{i , j} \vert}^{2} {σ}_{i}^{2}} .$$

To avoid underestimating the radiated EVM with the conductive measurement, the maximum combining gain can be removed from the EVM measurement by multiplying by the square root of Gᵢ so that

$${EVM}_{i}^{′} = {EVM}_{i} \sqrt{{G}_{i}} .$$

Alternatively, since the correlation of the radiated transmitter noise may not be worst case, it may be better to scale the conductive EVM measurement by a fraction f of the maximum combining gain so that

$${EVM}_{i}^{′} = {EVM}_{i} \cdot f \cdot \sqrt{{G}_{i}} ,$$

where f is a real-valued scalar in the interval (0, 1].

If we consider an example two-layer precoder given by

$$w = \frac{1}{2 \sqrt{2}} [ \begin{matrix}1 & 1 \\ 1 & 1 \\ 1 & - 1 \\ 1 & - 1\end{matrix} ]$$

and consider the chase that H=I, then

B=((HW)^{H}HW)⁻¹(HW)^{H}H=W^{H}.

For this example, we have

$${G}_{i} = \frac{{( {\sum }_{j = 1}^{4} \vert {B}_{i , j} \vert {σ}_{i} )}^{2}}{{\sum }_{j = 1}^{4} {\vert {B}_{i , j}^{2} \vert}^{2} {σ}_{i}^{2}} = 4$$

for all i.

It can be noted that this same approach can be used with any other linear MIMO receiver. According to a one possible example, the linear unbiased MMSE receiver can be used. In this case, the matrix B can be defined as

B=A_{MMSE,U} H,

where A_{MMSE,U} is the unbiased MMSE receiver, where the U means unbiased. For example, A_{MMSE,U} can denote a linear unbiased MMSE MIMO receiver, which can be a matrix.

At least some embodiments can provide EVM adjustment using an allowed increase of MPR/Additional MPR (A-MPR) for multi-antenna transmission ports.

In some cases, increased MPR or additional A-MPR is allowed for multi-antenna transmission. These increased values are typically based on PA measurements taken using conductive measurements but with coupling between the PA's introduced using directional couplers in order to emulate the coupling that occurs between antennas with limited isolation. An example of the increased MPR can be seen in Table 6.2.2-2 and 6.2D.2-1 below. It can be observed that for CP-OFDM 64 QAM, the dual Tx MPR is 4.5 dB while the single antenna MPR is 3.5 dB. For CP-OFDM 256 QAM, the dual Tx MPR is 8.0 dB while the single antenna MPR is 6.5 dB. Thus, for CP-OFDM 64 QAM, MPR is increased by 1.0 dB while for 256 QAM MPR is increased by 1.5 dB.

TABLE 6.2.2-2
MPR for power class 2 (single antenna transmission)

| | | MPR (dB) | | |
|---|---|---|---|---|
| | | Edge RB | Outer RB | Inner RB |
| Modulation | | allocations | allocations | allocations |
| DFT-s- | Pi/2 | ≤3.5 | ≤0.5 | 0 |
| OFDM | BPSK | | | |
| | QPSK | ≤3.5 | ≤1 | 0 |
| | 16 QAM | ≤3.5 | ≤2 | ≤1 |
| | 64 QAM | ≤3.5 | ≤2.5 | |
| | 256 QAM | ≤4.5 | | |
| CP- | QPSK | ≤3.5 | ≤3 | ≤1.5 |
| OFDM | 16 QAM | ≤3.5 | ≤3 | ≤2 |
| | 64 QAM | ≤3.5 | | |
| | 256 QAM | ≤6.5 | | |

TABLE 6.2D.2-1
MPR for power class 2 with dual Tx (same signal for 2
antennas for transmit diversity)

| | | MPR (dB) | | |
|---|---|---|---|---|
| | | Edge RB | Outer RB | Inner RB |
| Modulation | | allocations | allocations | allocations |
| DFT-s- | Pi/2 | ≤3.5 | ≤1 | 0 |
| OFDM | BPSK | | | |
| | QPSK | ≤3.5 | ≤2 | 0.5 |
| | 16 QAM | ≤3.5 | ≤2.5 | ≤1.5 |
| | 64 QAM | ≤3.5 | <3 | |
| | 256 QAM | ≤5.5 | | |
| CP- | QPSK | ≤4.0 | ≤3.5 | ≤2 |
| OFDM | 16 QAM | ≤4.0 | ≤3.5 | ≤2.5 |
| | 64 QAM | ≤4.5 | | |
| | 256 QAM | ≤8.0 | | |

Instead of using the maximum combining gain to estimate the radiated EVM from the conducted EVM, an alternative is to use the increase in the MPR allowed for multi-antenna transmission to estimate the conducted EVM. With this approach, the MPR measurements can emulate the expected coupling between the antennas.

To adjust the conducted EVM measurement to reflect the increased MPR, there should be a mapping between the need for increased MPR and the increased EVM due to antenna coupling. The EVM that is allowed for each modulation type is shown in the Table 6.4.2.1-1 below.

TABLE 6.4.2.1-1
Requirements for Error Vector Magnitude

| Parameter | Unit | Average EVM Level |
|---|---|---|
| Pi/2-BPSK | % | 30 |
| QPSK | % | 17.5 |
| 16 QAM | % | 12.5 |
| 64 QAM | % | 8 |
| 256 QAM | % | 3.5 |

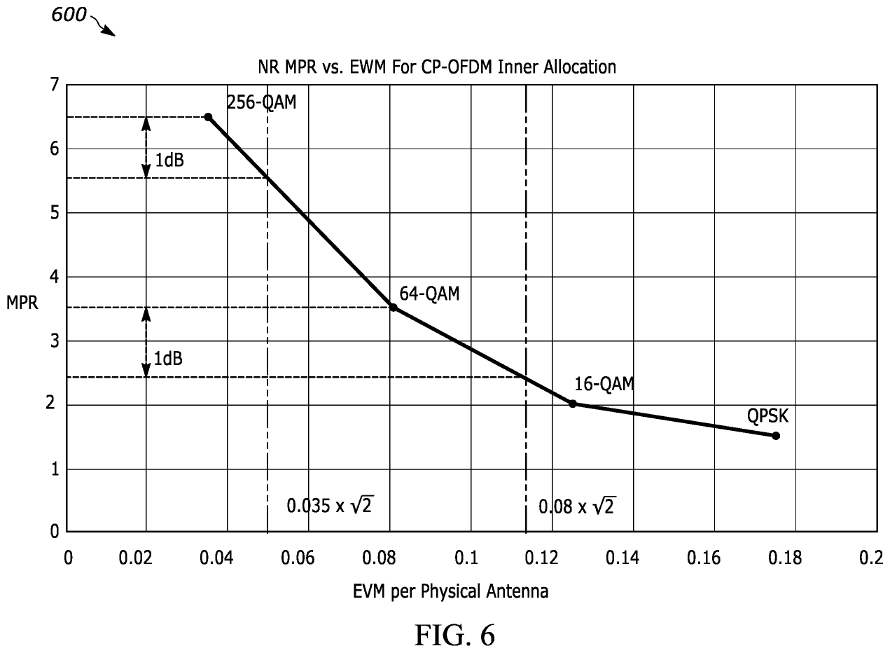

FIG. 6 is an example illustration 600 of a relationship between EVM and MPR according to a possible embodiment. From this illustration, it can be observed that as the MPR is increased by 1 dB, the EVM is decreased by approximately \sqrt{2}. This relationship can be expressed as

EVM₂=EVM₁\sqrt{2}^{ΔMPR}=EVM₁2^{(ΔMPR/2)}

where EVM₁ and EVM₂ are the EVM values before and after the power reduction by ΔMPR. From this relationship, the relationship between the conducted EVM measurement and the radiated EVM measurement can be expressed as

EVM_{radiated=EVM}_{conductive}2^{(ΔMPR/2)}

where ΔMPR is the increased MPR allowed for dual Tx for the given modulation type. In some cases, it may be better to adjust the radiated EVM by only a fraction f of this increase so that

EVM_{radiated=EVM}_{conductive}f·2^{(ΔMPR/2)},

where f is a real-valued scalar in the interval (0, 1].

At least some embodiments can define the EVM for 4 Tx transmission on a per layer basis. At least some embodiments can, for full-rank transmission, measure the conductive EVM using a zero-forcing MIMO receiver. At least some embodiments can, for less than full-rank transmission, measure the conductive EVM using a pseudo-inverse receiver. At least some embodiments can account for antenna correlation not observed in conductive measurements by increasing the conductive EVM measurement by some fraction of the square root of the maximum combining gain so that

EVMᵢ′=EVMᵢ·f·\sqrt{Gⁱ},

where f is a real-valued scalar in the interval (0, 1]. Alternatively, at least some embodiments can provide, in the case that increased MPR is defined for multi-antenna transmission, increasing the conductive EVM measurement by

EVM_{radiated=EVM}_{conductive}f·2^{(ΔMPR/2)},

where f is a real-valued scalar in the interval (0, 1].

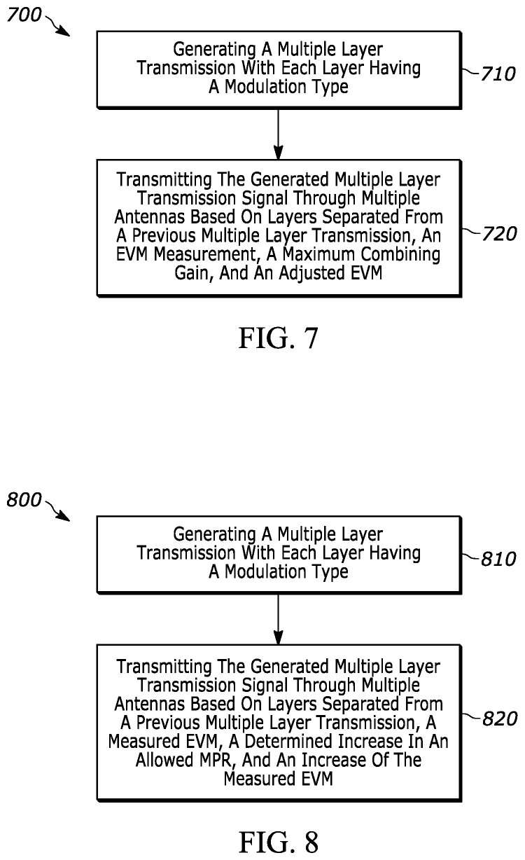

FIG. 7 is an example flowchart 700 of a method in a device, such as the UE 110, according to a possible embodiment. At 710, the method can include generating a multiple-layer transmission with each layer having a modulation type. At 720, the method can include transmitting the generated multiple-layer transmission signal through multiple antennas.

The transmission of the generated multiple-layer transmission can be based on layers separated from a previous multiple-layer transmission by using a matrix MIMO receiver having matrix coefficients. The transmission of the generated multiple-layer transmission can also be based on an EVM measurement for at least one layer of the separated layers. The transmission of the generated multiple-layer transmission can also be based on a maximum combining gain of the MIMO receiver determined for each layer based on the receiver matrix coefficients. The maximum combining gain can determined for a particular layer based on a fraction of a pre-set maximum combining gain, a MIMO receiver matrix of the MIMO receiver, and a matrix of a transmission channel. The MIMO receiver can be a zero-forcing MIMO receiver, a linear unbiased MMSE MIMO receiver, a pseudo-inverse MIMO receiver, or other MIMO receiver. The transmission of the generated multiple-layer transmission can also be based on an adjusted EVM generated by multiplying the measured EVM by a fraction of a square root of the maximum combining gain.

According to a possible embodiment, the transmission of the generated multiple-layer transmission can also be based on a comparison of the adjusted EVM to an EVM threshold predefined for the modulation type of at least one layer. The method can include other operations discussed above.

FIG. 8 is an example flowchart 800 of a method in a device, such as the UE 110, according to a possible embodiment. At 810, the method can include generating a multiple-layer transmission with each layer having a modulation type. At 820, the method can include transmitting the generated multiple-layer transmission signal through multiple antennas.

Transmission of the generated multiple-layer transmission can be based on layers separated from a previous multiple-layer transmission of the modulation type by using a matrix MIMO receiver having matrix coefficients. Transmission of the generated multiple-layer transmission can also be based on a measured EVM for at least one layer for the separated layers. Transmission of the generated multiple-layer transmission can also be based on a determined increase in an allowed MPR for the modulation type for the at least one layer. Transmission of the generated multiple-layer transmission can also be based on an increase of the measured EVM for the at least one layer by a function of an allowed MPR increase for the modulation type. For example, the transmission of the generated multiple-layer transmission can be based on the previously separated layers, the measured EVM, the determined increase in the allowed MPR, and the increase of the EVM measurement by the device satisfying a requirement that is tested using these parameters. The method can include other operations discussed above.

Embodiments above can further be based on the following descriptions.

UEs can have multiple antennas. The number or antennas at each end, such as at the UE and at the base station, should be at least equal to the number of layers. A UE or base station may compute its own EVM, but generally this can be done at test equipment.

For conductive measurements, test equipment can be connected to at least one antenna connector to take measurements. Contrary to conductive measurements, radiated measurements can be taken without the test equipment connecting to the antenna connectors, such as by measuring the radiated fields outside the device.

The EVM measurement is a requirement on the quality of the transmitted signal. The larger the EVM, the worse the signal-to-noise ratio at the receiver. The UE transmits a transmission of the modulation type with the required EVM for the modulation type and with the required power level. The required power level can be based on MPR.

The allowed MPR can be increased for multiple Tx, such as multiple transmit antennas. A table can provide the allowed MPR for four transmit antennas (4 Tx). The tables above disclosure show 1 Tx and 2 Tx.

MPR should reflect antenna impairments. However, these impairments may not be seen when conductively measuring, such as when taking measurements of a conductively received transmission. The impairments can be artificially added, not measured, when testing using conductive measurements. For example, a coupler can be inserted between the output of one PA and the output of another other PA to reflect the impairment based on assumptions that coupling will occur. As a further example, the coupling may not be known when doing conductive instead of radiated measurements. Thus, the coupling can be approximated or based on an assumption. The coupling can cause the transmitter noise to be correlated, which can result in the loss of some combining gain.

Embodiments can adjust a conductive measurement, or what it is compared to, in order to account for antenna coupling. The measurement or what it is compared to can be adjusted for impairments that are not seen when performing conductive measuring. This can be done based on a fraction of combining gain, a fraction the MPR, and or other adjustments. For example, if more MPR is allowed, conductive measurements can be penalized to reflect the need for increased MPR.

The EVM can also be increased based on expected degradation that may or may not occur. The degradation can be based on the transmitter noise becoming correlated due to antenna coupling and causing loss of combining gain in the receiver. It can also be based on reverse intermodulation due to antenna coupling or other degradation factors. The adjusted EVM can be less than a specified required EVM value, which can be a percent based on the modulation type being used.

A UE can be tested for each constellation type of 16 QAM, 64 QAM, QPSK, and/or other constellation type. The UE can increase MPR, such as lower its power, to meet an EVM requirement. The max power required to transmit QPSK can be higher than 64 QAM. The MPR can be optional, so as much power can be used for QAM as QPSK for transmission when using a good transmitter. For example, increasing power causes more impairments because the transmitter is operating in a more non-linear region while reducing power puts the transmitter in a more linear region and reduces signal impairments.

The UE can transmit to meet the EVM requirement. The UE can be set for the EVM requirement before retail sale, but it may also be allowed to calibrate itself. The EVM requirement can be a function of the modulation type.

The formula that is defined for maximum combining name can be applied for a zero-forcing receiver for 4-layer transmission, for the pseudo-inverse receiver for the case that the number of layers is less than 4, and for other receiver types such as the linear unbiased MMSE receiver.

In all the embodiments, any component that performs an action, function, process, calculation, configuration, determination, and other operations can be configured to perform the operations.

Appendix: Maximum Transmitter Noise Variance with Correlated Transmitter Noise.

For 4×4 UL MIMO, the variance of the transmitter noise at the output of the zero-forcing receiver is given by

$$\begin{matrix}E ( v {v}^{H} ) = {W}^{H} E ( n {n}^{H} ) W \\ = {W}^{H} Σ W ,\end{matrix}$$

$$where Σ = E ( n {n}^{H} ) = [ \begin{matrix}{σ}_{1}^{2} & … & {ε}_{1 , N} \\ ⋮ & ⋱ & ⋮ \\ {ε}_{N , 1} & … & {σ}_{N}^{2}\end{matrix} ] and {ε}_{i , j} = E ( {n}_{i} {n}_{j}^{*} ) .$$

The noise variance for the i-th layer is given by

$${( {W}^{H} Σ W )}_{i , i} = {\sum }_{k = 1}^{N} {\sum }_{j = 1}^{N} {W}_{j , i}^{*} {Σ}_{j , k} {W}_{k , i} .$$

Expanding and using the fact that

$${ε}_{i , j} = {ε}_{i , j}^{*} ,$$

this gives

$$\begin{matrix}{( {W}^{H} Σ W )}_{i , i} = {\sum }_{k = 1}^{N} {\sum }_{j = 1}^{N} {W}_{j , i}^{*} {W}_{k , i} {ε}_{j , k} \\ = {\sum }_{k = 1}^{N} {\sum }_{j = 1}^{k - 1} ( {W}_{j , i}^{*} {W}_{k , i} {ε}_{j , k} + {W}_{k , i}^{*} {W}_{j , i} {ε}_{k , j} ) + {\sum }_{j = 1}^{N} {\vert {W}_{j , i} \vert}^{2} {ε}_{j , i} \\ = {\sum }_{k = 1}^{N} {\sum }_{j = 1}^{k - 1} 2 Re ( {W}_{j , i}^{*} {W}_{k , i} {ε}_{j , k} ) + {\sum }_{j = 1}^{N} {\vert {W}_{j , i} \vert}^{2} {σ}_{j}^{2} , \\ {\leq \sum }_{k = 1}^{N} {\sum }_{j = 1}^{k - 1} 2 \vert {W}_{j , i}^{*} \vert \vert {W}_{k , i} \vert \vert {ε}_{j , k} \vert + {\sum }_{j = 1}^{N} {\vert {W}_{j , i} \vert}^{2} {σ}_{j}^{2} .\end{matrix}$$

Let ρ_{i,j}=|ε_{i,j}|/σᵢσⱼ and note that ρ_{i,j}≤1, so that

$${( {W}^{H} Σ W )}_{i , i} \leq {\sum }_{k = 1}^{N} {\sum }_{j = 1}^{k - 1} 2 \vert {W}_{j , i}^{*} \vert \vert {W}_{k , i} \vert {ρ}_{i , j} {σ}_{i} {σ}_{j} + {\sum }_{j = 1}^{N} {\vert {W}_{j , i} \vert}^{2} {σ}_{j}^{2} \leq {\sum }_{k = 1}^{N} {\sum }_{j = 1}^{k - 1} 2 \vert {W}_{j , i}^{*} \vert \vert {W}_{k , i} \vert {σ}_{i} {σ}_{j} + {\sum }_{j = 1}^{N} {\vert {W}_{j , i} \vert}^{2} {σ}_{j}^{2} = {( {\sum }_{j = 1}^{N} \vert {W}_{j , i} \vert {σ}_{i} )}^{2} .$$

At least some methods of this disclosure can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

At least some embodiments can improve operation of the disclosed devices. Also, while this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The phrase “at least one of,” “at least one selected from the group of,” or “at least one selected from” followed by a list is defined to mean one, some, or all, but not necessarily all of, the elements in the list. The terms “comprises,” “comprising,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.” Furthermore, the background section is not admitted as prior art, is written as the inventor's own understanding of the context of some embodiments at the time of filing, and includes the inventor's own recognition of any problems with existing technologies and/or problems experienced in the inventor's own work.

1. A user equipment (UE) for wireless communication, comprising:
at least one memory; and
at least one processor coupled with the at least one memory and configured to cause the UE to:
separate layers from a conductively received multiple-layer transmission by using a matrix multiple-input multiple-output (MIMO) receiver having matrix coefficients, wherein each layer of the received multiple-layer transmission has a modulation type;
measure an error vector magnitude (EVM) for at least one layer of the separated layers;
determine an increase in an allowed maximum power reduction (MPR) for the modulation type for the at least one layer; and
increase the measured EVM for the at least one layer by a function of an allowed MPR increase for the modulation type.

2. The UE of claim 1, wherein to increase the measured EVM, the at least one processor is further configured to cause the UE to increase the measured EVM to an increased EVM measurement is increased based at least in part on a product of the EVM measurement, a scalar, and an amount of increase of an allowed MPR.

3. The UE of claim 2, wherein to increase the measured EVM, the at least one processor is further configured to cause the UE to increase the measured EVM based at least in part on
EVM_{increased}=EVM_{conductive} f·2^{(ΔMPR/2)}
where
EVM_{conductive} is the measured EVM of the conductively received transmission,
f is a real-valued scalar in an interval (0,1],
ΔMPR is an amount of increase of the allowed MPR in dB, and
EVM_{increased} is the increased EVM measurement.

4. The UE of claim 1, wherein the at least one processor is further configured to cause the UE to compare the increased measured EVM to an allowed EVM to determine whether an allowed EVM requirement is satisfied.

5. The UE of claim 4, wherein the allowed EVM requirement is different for at least two different modulation types.

6-10. (canceled)

11. A base station for wireless communication, comprising:
at least one memory; and
at least one processor coupled with the at least one memory and configured to cause the base station to:
generate a multiple-layer transmission, wherein each layer has a modulation type; and
transmit the generated multiple-layer transmission through multiple antennas, wherein the transmission of the generated multiple-layer transmission is based at least in part on
layers separated from a previous multiple-layer transmission of the modulation type by using a matrix multiple-input multiple-output (MIMO) receiver having matrix coefficients,
a measured error vector magnitude (EVM) for at least one layer of the separated layers,
a determined increase in an allowed maximum power reduction (MPR) for the modulation type for the at least one layer, and
an increase of the measured EVM for the at least one layer by a function of an allowed MPR increase for the modulation type.

12. The base station of claim 11, wherein the measured EVM is increased to an increased EVM measurement based at least in part on a product of the EVM measurement, a scalar, and an amount of increase of an allowed MPR.

13. The base station of claim 12, wherein the EVM measurement is increased based at least in part on
EVM_{increased} 1=EVM_{conductive} f·2^{(ΔMPR/2)}
where
EVM_{conductive} is the measured EVM of the multiple-layer transmission,
f is a real-valued scalar in an interval (0,1],
ΔMPR is an amount of increase of the allowed MPR in dB, and
EVM_{increased} is the increased EVM measurement.

14. The base station of claim 11, wherein to transmit the generated multiple-layer transmission, the at least one processor is further configured to transmit the generated multiple-layer transmission based at least in part on a comparison of the increased EVM measurement to an allowed EVM to determine whether an allowed EVM requirement is satisfied.

15. The base station of claim 11, wherein the increase in the allowed MPR is based on a number of antennas used for transmission.

16. A method in a device, the method comprising:
conductively receiving a multiple-layer transmission with each layer having a modulation type;
separating layers from the received multiple-layer transmission by using a matrix multiple-input multiple-output (MIMO) receiver having matrix coefficients;
measuring an error vector magnitude (EVM) for at least one layer of the separated layers;
determining an increase in an allowed maximum power reduction (MPR) for the modulation type for the at least one layer; and
increasing the measured EVM for the at least one layer by a function of an allowed MPR increase for the modulation type.

17. The method of claim 16, wherein increasing the measured EVM comprises increasing the measured EVM to an increased EVM measurement based at least in part on a product of the EVM measurement, a scalar, and an amount of increase of an allowed MPR.

18. The method of claim 17, wherein increasing the measured EVM comprises increasing the measured EVM based at least in part on
EVM_{increased}=EVM_{conductive} f·2^{(ΔMPR/2)}
wherein
EVM_{conductive} is the measured EVM of the conductively received transmission,
f is a real-valued scalar in an interval (0,1],
ΔMPR is an amount of increase of an allowed MPR in dB, and
EVM_{increased} is the increased EVM measurement.

19. The method according to of claim 16, further comprising comparing the increased measured EVM to an allowed EVM to determine whether an allowed EVM requirement is satisfied.

20. The method of claim 19, wherein the allowed EVM is different for at least two different modulation types.

21. A method in a device, the method comprising:
generating a multiple-layer transmission, wherein each layer has a modulation type; and
transmitting the generated multiple-layer transmission through multiple antennas, wherein the transmission of the generated multiple-layer transmission is based at least in part on
layers separated from a previous multiple-layer transmission of the modulation type by using a matrix multiple-input multiple-output (MIMO) receiver having matrix coefficients,
a measured error vector magnitude (EVM) for at least one layer of the separated layers,
a determined increase in an allowed maximum power reduction (MPR) for the modulation type for the at least one layer, and
an increase of the measured EVM for the at least one layer by a function of an allowed MPR increase for the modulation type.

22. The method of claim 21, wherein the measured EVM is increased to an increased EVM measurement based at least in part on a product of the EVM measurement, a scalar, and an amount of increase of an allowed MPR.

23. The method of claim 22, wherein the EVM measurement is increased based at least in part on
EVM_{increased}=EVM_{conductive} f·2^{(ΔMPR/2)}
where
EVM_{conductive} is the measured EVM of the multiple-layer transmission,
f is a real-valued scalar in an interval (0,1],
ΔMPR is an amount of increase of the allowed MPR in dB, and
EVM_{increased} is the increased EVM measurement.

24. The method of claim 21, wherein transmitting the generated multiple-layer transmission further comprises transmitting the generated multiple-layer transmission based at least in part on a comparison of the increased EVM measurement to an allowed EVM to determine whether an allowed EVM requirement is satisfied.

25. The method of claim 21, wherein the increase in the allowed MPR is based on a number of antennas used for transmission.
